(19) United States
(12) Patent Application Publication
(10) Pub. No.: US 2017/0326556 A1
(43) Pub. Date: Nov. 16, 2017

(54) Method And Device For Separating Materials According To Their Density

(71) Applicant: AKAI GmbH & Co. KG, Kolbermoor (DE)

(72) Inventor: Alexander Koslow, Landshut (DE)

(21) Appl. No.: 15/528,344

(22) PCT Filed: Nov. 17, 2015
(86) PCT No.: PCT/DE2015/000543

§ 371 Date: May 19, 2017

(30) Foreign Application Priority Data
Nov. 19, 2014 (DE) 10 2014 017 132.9

(51) Int. Cl. B03B 5/14; B03B 13/00; B03B 5/24

(52) U.S. Cl. CPC B03B 5/14; B03B 5/24; B03B 13/00

(57) ABSTRACT

The separation of materials according to their density is carried out in a fluid bath by floating ground light materials and carrying same over an overflow, as well as depositing ground heavier materials on a horizontal sieve base within the fluid bath. In order to improve the floating of the lighter materials, a displacement body is cyclically sunk into the fluid bath. The fluid bath is supplied with additional fluid in a synchronous manner with the cyclical movement of the displacement body. A control device for supplying the fluid can also be connected to pressure sensors or the drive of the displacement body.

### FIELD OF THE INVENTION

Method and device for separating materials according to their density.

### BACKGROUND OF THE INVENTION

Methods and devices for separating materials according to their density are known in the state of the art of technology. In such a method, for example, a mixture of materials of various specific weights (density) is created by grinding the materials in a shredder device or a hammer mill and separating them in a subsequently connected sieve to a preferentially homogeneous grain size. Such mixtures, however, can also be very heterogeneous according to size, density, surface composition, etc.

The mixture so obtained is placed by a movement device into a fluid bath, for example a water bath, which is located in a container, a setting box. The water bath is subdivided into two bath sections by a sieve floor (setting floor) running horizontally across the container.

The mixture that is run through the sieve is made of materials of various specific weights that are inserted into the section of the water bath above the sieve. Specific lighter parts of materials float in the water bath on its surface and are removed by an overflow out of the water bed. Specific heavier parts of material drop down onto the sieve.

To facilitate the floating of the lighter materials, a displacement body inserted cyclically can create changes in pressure and flows in the water bath, which support the floating of lighter pieces of material.

The pieces of material set on the sieve can for example be removed by having the sieve perform a horizontal motion, which moves slowly in one direction and quickly in the opposite direction, and at the same time before reaching the wall of the container, abruptly stops, so that the drop down sediment settles on the sieve, and due to the inherent kinetic energy of the acceleration is removed over a simultaneously opened crack between the end of the sieve and the wall of the container through the crack.

A plunger setting machine is known from DE 887 181, which upon lifting of the plunger (intake stroke), a balance occurs between the suction exerted on the setting material by the introduction of additional fluid into the setting box.

The known methods and devices work in a rather time-consuming manner, since the light portions of material flow only slowly. Thereby these processes are less efficient and do not allow the separation of heterogeneous material mixtures with high accuracy.

### SUMMARY OF THE INVENTION

The task of the invention is to provide a better method and a device for separating the material mixtures according to their density.

This task is resolved by the invention that is defined in the independent patent claims; embodiments of the invention are defined in the dependent claims.

According to one aspect, additional fluid is introduced into the fluid bath depending on the working cycle of the displacement body, controlled according to amount, pressure, and time in the working cycle. The pressure in the fluid bath can be measured as a parameter for control.

When the displacement body is raised out of the fluid bath, a suction effect occurs, which sucks back the already floating material onto the sieve. The invention works against this suction, in that an additional amount of fluid equivalent to movement of the displacement body is inserted.

When the displacement body is dipped into the fluid bath, depending on the composition of the material mixture, a specific amount of additional fluid is inserted in order to reinforce the upward movement that is created by the dipped in displacement body and thereby allows the desired heavy material parts to float, which otherwise would remain on the floor of the sieve. The buoyancy on the sieve can thus be controlled exactly. Thereby a fine separation is possible between heavy material parts and even heavier parts.

In the device for separating materials according to their density, at least one insertion of fluid is planned in the area of the setting box lying below the sieve. The flow of the fluid is regulated by a control device according to pressure and amount, so that on one side the buoyancy for the lighter materials is improved and on the other side is hindered, so that a suction effect occurs in the water bath when the displacement body is lifted.

The insertion of fluid into the area of the fluid container lying below the sieve occurs synchronously with the movement of the cyclically dipped displacement body. The control device for inserting fluid working synchronously with the cyclical movement of the displacement body works in a manner that when the displacement body is dipped, an adjustable amount of fluid can be added to the material, and when the displacement body in the fluid bath is lifted, the inflow of additional fluid can be so controlled that no suction occurs in the fluid bath.

The fluid to be inserted (e.g., water) is to be so measured on both movements of the displacement body so that on the one hand it supports the buoyancy of the lighter materials, and on the other hand the sinking of the heavy materials is not prevented.

In the same way the time for the introduction of the fluid into the method cycle is determined so that this occurs synchronously with the movement of the displacement body.

Upon lifting, the fluid is inserted in a way that its amount corresponds to the particular volume caused by pulling out the displacement body from the fluid bath, and as a result no suction effect occurs in the fluid bath that would lead to the result that already floating material is sucked again in the direction of the sieve.

The upwards directed stream in the fluid caused by the dipping of the displacement body is supported by simultaneously controlled insertion of additional fluid, whose amount is determined according to the materials to be separated. With higher buoyancy power thus achieved, even heavier materials can be made to float and removed through the overflow, in particular such parts that present a large opposing surface to the buoy flow and that otherwise would be set on the floor of the sieve (e.g., larger or very large pieces of plastic).

Control can occur through pressure sensors and the fluid bath or through measurement devices on the driving gear of the displacement body. This control activates one or several valves corresponding to the number of intakes for the fluid to be inserted. A pressure sensor in the fluid bath can work together with a fluid drive pump to control its revolutions and its drive pressure and thereby the amount being driven. For balance, a manually activated valve can be provided in the insertion pipe for the fluid.

### BRIEF DESCRIPTION OF THE DRAWINGS

FIG. 1 is a schematic view of an embodiment of the present invention.

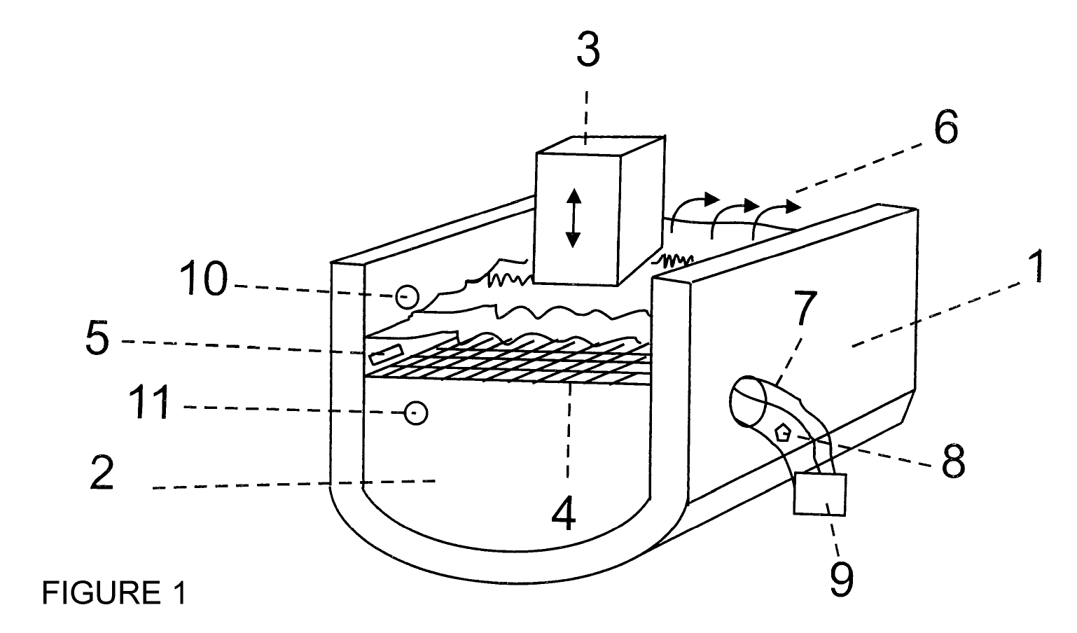

### DETAILED DESCRIPTION OF THE INVENTION

The fluid container (setting box) 1 contains a fluid bath 2 (preferentially water) and is filled up to an overflow 6 that carries away floating materials. At about half the height of the fluid in the setting box 1 there is arranged at least a horizontally movable sieve floor 4.

In the fluid bath, an amount of various materials (with various densities) is added. Material of lower density floats in the fluid bath up to the surface and is carried off by the overflow 6. Heavier materials sink to the sieve floor 4 and there form a layer of sediment, which is carried off periodically by a horizontal back and forth movement of the sieve floor 4 through an opening 5, which can be formed as a crack in the wall of the fluid container 1. In this way there is a systematic separation of materials of various densities.

To accelerate the separation, a displacement body 3 can be provided in the fluid bath 2, which cyclically dips into the fluid bath 2 and creates an exactly defined change in pressure, which is empirically determined according to the material to be separated and increases the buoyancy of lighter materials.

A pressure sensor 11 in the area below the sieve floor 4 measures the pressure in the fluid bath and supplies to it control elements 8 of a control and regulation device 9 for the insertion of additional fluid.

When the displacement device 3 is lifted in the fluid bath 2, suction (and thereby a drop in pressure) arises that must be prevented, so that material that is not already floating should not be sucked back onto the sieve floor 4. In order to prevent such suction in the fluid bath 2, a controlled supply pipe for additional fluid 7 is connected to the setting box under the sieve floor 4.

The control of the fluid insertion occurs synchronously with the movement of the displacement body 3.

When the displacement body 3 is dipped into the fluid bath 2, the amount of additional fluid depending on the material mixture to be separated is so controlled that not only light materials can be separated, which float beforehand, but also heavy materials and even heavier materials can be separated, which without the controlled insertion of additional fluid would both be set on the sieve floor.

The controlled insertion of fluid when the displacement body is dipped—which leads to stronger screening (or greater changes in pressure) in the fluid bath than through the dipping of the displacement body alone—allows the invention to have a flexible and rapid adjustment of the separating action on the particular heterogeneous mixture material that is present of light, heavy, and heavier materials.

When the displacement body 3 is lifted out of the fluid bath 2, additional fluid is brought into the fluid bath 2 under pressure, so that no suction (drop in pressure) occurs in the fluid bath 2; to this end, the amount of the additional fluid is set according to the volume of fluid released by the lifting.

A connection to the control device 9 can exist between the displacement body 3 and its drive gear, which controls the additional amount of fluid according to time, pressure, and amount, alone or working together with the pressure sensors.

Sensors 10 can also be arranged in the area above the sieve floor 4, which deliver control signals for the insertion of additional fluid.

The material that is taken out by the overflow 6 and the material given off from the sieve via the opening 5 in each case are imaged by a video camera and displayed by a display device (monitor). The service staff can thereby perform a manual fine control of the input of additional fluid and thereby intentionally affect the separation work of the device, depending on the observed current results of the separation.

In the method and device that are described, additional fluid is inserted into the fluid bath continuously and controlled, both when inserting the displacement body and when lifting it out. Thereby a movement is created in the fluid bath that can be set at the material mixture that is to be separated and that allows a targeted and defined separation between light, heavier, and heavy material components. In particular in this way floating pieces of material are no longer brought in the direction of the sieve floor.

### LIST OF COMPONENTS

1 Fluid container
2 Fluid bath
3 Displacement body
4 Sieve floor
5 Opening for carrying off the heavy material
6 Overflow for carrying off the light material
7 Supply pipe for additional fluid
8 Control elements for inserting additional fluid
9 Control device for pressure, amount, and time of inserting additional fluid
10 Sensors
11 Sensors under the sieve floor for setting the pressure in the fluid container 1

1. A method for separating mixtures of ground materials according to their density in a fluid bath with at least one sieve floor, on which heavier parts of the inserted mixtures sit, and a device to create a cyclical change of pressure in the fluid bath,
so characterized in that
during an increase in pressure a predetermined amount of additional fluid is inserted into the fluid bath.

2. The method according to claim 1, wherein the predetermined amount of additional fluid is determined according to the composition of the mixture to be separated.

3. A device for separating mixtures of ground materials according to their density in a fluid bath with at least one sieve floor, on which heavier parts of the inserted mixture sit and with a displacement body, which is dipped cyclically into the fluid bath,
so characterized in that
a control device is provided, which during dipping of the displacement body introduces a predetermined amount of additional fluid into the fluid bath via a supply pipe.

4. The device according to claim 3, wherein the predetermined amount of additional fluid is determined by the composition of the mixture to be separated.

5. The device according to claim 3, wherein pressure sensors are provided in the fluid bath under the sieve floor, which deliver control signals to the control device.

6. The device according to claim 3, wherein a formative device in each case indicates the separated parts of material for manual fine control of the additional fluid.

7. The device according to claim 3, wherein the control device introduces fluid when the displacement body is lifted in an amount that corresponds to the volume of fluid that is taken up by the displacement body.
